(19) United States
(12) Patent Application Publication
(10) Pub. No.: US 2006/0025515 A1
(43) Pub. Date: Feb. 2, 2006

(54) Nanotube composites and methods for producing

(75) Inventors: Robert P. Scaringe, Rockledge, FL (US); Dwight D. Back, Pembroke Pines, FL (US); John A. Meyer, Palm Bay, FL (US)

Correspondence Address: CROWELL & MORING LLP;INTELLECTUAL PROPERTY GROUP, P.O. BOX 14300, WASHINGTON, DC, 20044-4300, US

(73) Assignee: Mainstream Engineering Corp.

(21) Appl. No.: 10/898,933

(22) Filed: Jul. 27, 2004

(51) Int. Cl. C08K 3/04

(52) U.S. Cl. 524/496

(57) ABSTRACT

A method for producing a carbon nanotube composite, in which carbon nanotubes are grown on a support substrate and metal catalyst. The carbon nanotubes, support substrate, and catalyst are combined in at least a partially unpurified form with a matrix material.

### CROSS-REFERENCE TO RELATED APPLICATION

This application is related to patent application Ser. No. 10/831,157, filed Apr. 26, 2004, now pending.

The U.S. Government has a paid-up license in this invention and the right in limited circumstances to require the patent owner to license others on reasonable terms as provided for by the terms of Contract Nos. N00164-03-C-6023; N00167-03-C-0064; and N65540-03-C-0048 awarded by Naval Surface Warfare Center.

### BACKGROUND AND SUMMARY OF THE INVENTION

One of the most significant spin-off products of fullerene research, which lead to the discovery of the C60 “buckyball” by the 1996 Nobel Prize laureates Curl, Kroto, and Smalley, are nanotubes based on carbon or other elements. Carbon nanotubes are fullerene-related structures which consist of graphene cylinders closed at either end with caps containing pentagonal rings. A carbon nanotube is essentially a seamless honeycomb graphite lattice rolled into a cylinder. The single-walled nanotube (SWNT) diameter is about 1-3 nm, with lengths of 100's to 1000's nanometers. The multi-walled nanotube is comprised of about 10-100 concentric tubes with an internal diameter of about 1-10 nm and an outer diameter of up to about 100 nm. There are three types of carbon nanotubes which can comprise the SWNT's and MWNT's: armchair, zig-zag and helical (chiral) nanotubes. Within a particular allotrope, carbon nanotubes with many different radii can be found (i.e., SWNT's and MWNT's). These three allotropes differ in their symmetry. This symmetry can be described by how a hypothetical graphene sheet is ‘cut’ before being rolled up into a cylinder (i.e., the axis used for rolling the carbon sheet to make a seamless cylinder.) The density of carbon nanotubes is about 1.3-1.4 g/cm³ and the surface areas are typically on the order of 10³ m²/g.

The use of carbon nanotubes in composites has been pursued due to the unusual thermal conductivity, mechanical, mass transfer, and electrical conductivity properties the carbon nanotubes impart to the composites. For example, the thermal conductivity of carbon has been reported to be about 600 W/m-K. Pure diamond has a value of about 3300 W/m-K, whereas isolated carbon nanotubes can have thermal conductivities of about 6000 W/m-K. Hence, inclusion of these materials in composites can have dramatic effects on heat transfer. Similar examples can be found regarding electrical, mechanical and mass transfer (e.g., diffusion) properties.

Without the presence of carbon nanotubes, the composite matrix material is typically an insulator, e.g., a polymer, with poor electrical and thermal conductivity. Composites of up to about 2 weight percent carbon nanotubes in polymer resins have been successfully made. With regard to electrical conductivity, applications include polymer based light-emitting diodes, photodiodes, and sensors. Carbon nanotube composites have also been shown to have high tensile strength and Young's modulus. Due to their light weight, these composites are useful in structural or load bearing applications, or coatings and laminates to improve strength. Examples range from tennis rackets and magnetic recording media, to spacecraft parts. Other important applications for these composites include heat sinks for computer chip cooling, ballast and transformer housings, engine parts, static dissipaters, and semi-conducting shielding (e.g. computer and cell phone housings.) Alignment of the carbon nanotubes by applying a high magnetic field to the composites can also further enhance these properties. Coatings or films could also be used as membranes for gas or liquid separation, making use of the unusual mass transfer or diffusion characteristics of carbon nanotubes.

Metallic fillers have also been used to increase the thermal conductivity of polymers (typically about 0.1-0.5 W/m-K) and increase the electrical resistivity (typically 10¹⁴-10¹⁶ ohm-cm for polymers). Carbon black (e.g., graphitic carbon) has also been used as a filler to improve electrical properties of polymers, but has not been as effective in enhancing thermal conductivity. Chemically modified, or functionalized, carbon nanotubes have also shown improvements to these properties when used as fillers in polymers [see, e.g. U.S. Pat. No. 6,426,134].

There are several methods currently employed to produce nanotubes. Carbon nanotubes have been produced by an arc discharge between two graphite rods. Another method produces carbon nanotubes at high temperatures by irradiating a laser onto graphite or silicon carbide. Yet another method involved chemical vapor deposition (CVD) and plasma CVD. Catalyzed CVD is probably the most practical method for the production of carbon nanotubes. CVD is scalable and compatible with integrated circuit and MEMS manufacturing processes. CVD allows high specificity of single wall or multi wall nanotubes through appropriate selection of process gasses. Carbon feedstock comes from the decomposition of a feed gas such as carbon monoxide, methane or ethylene. Other hydrocarbon feeds such as acetylene, methanol, ethanol, toluene, xylene or benzene have also been used successfully.

Single-walled nanotubes (SWNT) or multi-walled nanotubes (MWNT) are typically grown on substrates which contain catalysts to promote their growth. Typical substrates, or support materials alumina, silica, carbon, zeolites, or combinations thereof. In most applications these high surface area substrates are used to disperse the catalysts in high concentrations. These growth support materials and catalysts are then typically separated from the nanotubes before the nanotubes can be used in any application. One method to separate the nanotubes from the support material is acid or base digestion. This digestion process can sometimes decompose or alter the nanotubes, and can be time-intensive and expensive. In many current applications the purified nanotubes must then be combined with a matrix such as a polymer.

The formation and growth of carbon nanotubes are facilitated by many metals and their oxides. These catalysts function by dissolving the carbon and then re-precipitating it into tubes and other nanoscale carbon structures. This process is best facilitated by metals which form solid solutions with the carbon such as Al, Co, Cr, Fe, Ir, Mn, Mo, Ni, Os, Pb, Pd, Pt, Rh, Ru, Ti, Y, and Zr. Metal catalysts currently preferred by those skilled in the art are selected from Fe, Mo, Ni, Y, Zn, Ru and Co which are deposited onto a support material such as alumina, silica, carbon, zeolites, or combinations thereof.

In U.S. Pat. No. 5,648,056, a fullerene/carbon nanotube composite is described. U.S. Pat. Nos. 5,780,101 and 5,965,267 describe a method for the production of carbon encapsulated metal particles using a gas mixture containing carbon monoxide for the use in thermal composites, reinforcement composites and magnetic particle recording media. The means to separate or purify the carbon coated metal particles used in their composites is not disclosed. Their definition of a catalyst in U.S. Pat. Nos. 5,780,101 and 5,965,267 is also uncertain in that the composites are taught by using carbon coated metal catalysts as required in recording media, yet the metal particles are deposited on a support material. Useful compositions of nanotubes in composites are not taught nor are the complications associated with forming these composites from pure nanotube structures.

U.S. Pat. No. 6,265,466 describes an electromagnetic shielding composite containing nanotubes and polymeric material. U.S. Pat. No. 6,426,134 relates to purified single-wall carbon nanotube/polymer composites and their use as fibers, films and articles. U.S. Pat. No. 6,683,783 discloses method for purifying a mixture comprising single-wall carbon nanotubes and amorphous carbon contaminate, and the use of the purified nanotubes in composites. U.S. Pat. No. 6,695,974 provides a fluid heat transfer agent suitable for use in a closed heat transfer system comprising a heat transfer fluid and suspended carbon nanoparticles which may encapsulate metal particles. U.S. Pat. No. 6,407,922 describes a heat spreader comprised of a polymer matrix with dispersed carbon nanotubes and/or thermal pyrolytic graphite flakes.

Thermal pastes, epoxies, adhesives, and greases are used to provide contact between two surfaces in order to transfer heat. Typically these surfaces are not able to be connected by mechanical means as in computer or semiconductor applications. They are also used to bond components such as thermocouples, thin film RTD's, and thermistors to surfaces comprised of glass, metal, ceramics, plastics, and papers. It is preferably that these pastes, greases, adhesives, and epoxies have a high thermal conductivity to maximize heat transfer between the surfaces. Current pastes comprise a silicone or oil base fluid filled with a compound such as zinc oxide, silver, boron nitride, aluminum, aluminum hydroxides, or alumina. These fillers increase the net thermal conductivity of the paste. Epoxies are also used to bind components permanently together. Typical epoxies known by those skilled in the art include, but are not limited to, polyesters, methacrylates, cyanoacrylates, acrylates, and bisphenol/epichlorohydrin with n-butyl glycidyl ether. Fillers used in these epoxies are similar to those used in pastes. Adhesives are typically categorized as drying adhesives, hot adhesives, temporary adhesives, and reactive adhesives. The most common reactive adhesives are epoxies.

Carbon nanotubes are known to possess very high thermal conductivities as well as low electrical resistivities, improved strength and unusual mass transfer properties. Due to the high surface area of carbon nanotubes, there are practical limitations to the amount of carbon nanotubes which can be combined with polymeric or organic matrices. Since thermal transport properties increase and electrical resistivity decreases as loadings are increased, a means to provide higher loadings of carbon nanotubes in a matrix would have great advantages.

### SUMMARY OF THE INVENTION

Our invention is based upon the discovery that there are production advantages and unexpected thermal properties when using carbon nanotubes, which have not been purified from the support and catalysts used to produce them, in composite matrices. Those skilled in the art have demonstrated the production of carbon nanotube composites comprising up to about 2 percent carbon nanotubes by weight. We have discovered that higher weight percent loadings of carbon nanotubes can be achieved by using unpurified nanotubes in the composites. The additional support material and metal catalysts also provide benefits in thermal conductivity for heat transfer applications. Higher loadings of carbon nanotubes in thermoset resins has been particularly difficult prior to this invention since the carbon nanotubes can adsorb or otherwise react with the polymers, monomers, and initiators.

Carbon nanotubes are grown from metal catalysts, typically transition metals, dispersed on supports such as alumina, silica and zeolites. In order to use these nanotubes, the support material and catalysts have previous to this invention been removed by various purification means including acid or base digestion. This purification process can damage and alter the carbon nanotubes, and also adds considerable time and cost to the process.

Carbon nanotubes are grown on a support material such as alumina, silica or zeolites which has one or more metals dispersed on it. In one currently preferred embodiment, carbon nanotubes and other carbon entities are grown by CVD on these supports and catalysts, and then the resulting powder is mixed with a matrix material to form a composite. Preferred matrix materials are oils (synthetic or natural), other organic fluids, and polymers. The powdery composition of carbon nanotubes, support material, catalyst, and other carbonaceous entities resulting from the CVD process can be mixed into the matrix by stirring, extrusion, blending, and/or sonication.

One way to grow nanotubes using the method of the present invention is by chemical vapor deposition (CVD). Other means known by those skilled in the art are contemplated as encompassing the methods of this invention such as plasma assisted CVD. These methods can produce single-walled and multi-walled carbon nanotubes comprised of armchair, zig-zag, and chiral allotropes.

The present invention provides the compositions and methods to prepare carbon nanotube composites in a manner which provides for higher loadings of carbon nanotubes and a greatly simplified and less costly process for producing the composites. Composites comprised of carbon nanotubes with polymers and organic fluids can be produced using the methods of this invention. The scope of the composites of the present invention includes polymer composites, adhesives, epoxies, greases and pastes.

Prior to our discovery, those it was known that thermal and electrical properties of composites comprising carbon nanotubes increase with loading, but high loadings of the carbon nanotubes was not practical, especially in epoxy resins since pure carbon nanotubes react adversely with the polymers and/or initiators. An object of the present invention is to enhance the thermal, electrical and mechanical properties of composites comprising carbon nanotubes in higher loadings than heretofore attainable.

Prior to the present invention the prior art accepted that carbon nanotubes are difficult to disperse in a polymer matrix due to the clumping together of the purified carbon nanotubes. Ultrasonics and surfactants have had to be employed to disperse the purified carbon nanotubes. The present invention eliminates the difficulty of dispersing carbon nanotubes in a polymer matrix and reduces the number of process steps needed to do so.

We have also discovered that in heat transfer applications, composites comprised of carbon nanotubes, amorphous carbon, and other carbon forms not characterized as nanotubes (and resulting from the CVD thermal decomposition reaction over a catalyst with hydrocarbon feedstock), a support material, and catalysts have surprising performance advantages over composites of prior art comprised of nanotubes alone or nanotubes which have encapsulated metal atoms.

Applications for nanotube composites include light weight load bearing structures, electronics, heat sinks, and a variety of other heat transfer components. Thermal pastes are used to couple a “hot” device to a heat transfer device to provide cooling to ambient air or other fluid.

We contemplate still further advantages of using the composites of this invention for structural or load bearing parts. The composites of this invention provide for improved interface strengths between the carbon nanotubes and polymers since the polymers can form strong interfaces with the support material and catalysts which are connected to the carbon nanotubes.

In the present invention, carbon nanotubes are grown using chemical vapor deposition (CVD) whereby a support material containing a catalyst of one or more metals is exposed to carbon feedstock gas at elevated temperatures. In order for a metal to facilitate carbon nanotube growth, carbon must form solid solutions with the metal at typical CVD nanotube growth temperatures (approx. 500° C. to 1200° C.). These metals include, but are not limited to: Al, Ag, Au, Be, Ca, Cd, Co, Cr, Fe, Ir, Li, Mn, Mo, Ni, Os, Pb, Pd, Pt, Rh, Ru, Si, Ti, V, W, Y, Zn, and Zr. Oxides of these metals can also catalyze the growth of carbon nanotubes. Most of these metals have thermal conductivities greater than about 80 W/m-K. The support materials for the catalysts are typically alumina, silica, carbon, zeolites, or combinations thereof. Other supports have also been used in the field of catalysis.

The carbon nanotubes are grown on the surface of the support material facilitated by the metal catalysts, and then removed from the CVD furnace. This material is then combined with a matrix material to form a composite. The matrix material can include thermoset polymers, thermoplastic polymers, greases, pastes, epoxies, adhesives, oils, and other organic compounds. The support material, catalyst, carbon nanotubes, and other carbonaceous entities produced by the CVD process can also be milled to produce a finer powder prior to combining with a matrix material. The support material, catalyst, carbon nanotubes, and other carbonaceous entities are typically combined with the matrix material up to about 50 percent by weight, although higher loadings are contemplated.

We have discovered that purified carbon nanotube-polymer resin composites are particularly difficult to prepare. The high surface area and reactivity of the carbon nanotubes has the propensity to adsorb or otherwise react with the polymer resins and initiators limiting the curability of the polymer resins. Practical limitations for polymer resins and epoxies using initiators are around 2 wt. % carbon nanotubes in the composites. The present invention is based upon the discovery, that by combining the support material, catalyst, carbon nanotubes, and other carbonaceous entities with the matrix material, higher net loadings of carbon nanotubes can be cured to form polymer composites.

Other advantages of this method include a decrease in process steps, a decrease in composite cost, and other property enhancements related to the presence of the metal atoms on the support material and carbon nanotubes. The network of metal atoms, support material, and carbon nanotubes produces a highly conductive and connective environment with advantages in electrical and thermal applications.

Another object of the present invention is to provide a method to produce polymer composites with high carbon nanotube loadings.

A still further object of this invention is to provide composites useful for heat sinks or thermal connection between two surfaces.

Another object of the present invention is to provide a means to produce carbon nanotube containing composites without the need for a structurally damaging or altering, costly and time intensive purification processes.

A further object of this invention is to provide a method to produce composites that are thermal pastes, greases, epoxies, and adhesives with higher carbon nanotube loadings.

One advantage of this invention is that the use of a support material, metal catalyst, carbon nanotubes, and other carbonaceous entities in composites produces unexpected improvements in thermal and electrical properties. Other carbonaceous entities produced during a CVD process include amorphous carbon, bucky onions, and fullerenes.

A related advantage of the present invention is that the thermal properties of a composite comprising a specific quantity of carbon nanotubes is improved when a support material, catalyst and other carbonaceous entities are included in the composite.

### BRIEF DESCRIPTION OF THE DRAWINGS

Other objects, advantages and novel features of the present invention will become apparent from the following detailed description of the invention when considered in conjunction with the accompanying drawings.

FIG. 1 is a drawing of a thermal paste connecting two bodies for heat transfer;

FIG. 2 is a drawing of a polymer composite plug;

FIG. 3 is a schematic cross-sectional view of a batch coating apparatus for carrying out a process using the method of the present invention;

FIG. 4 is a schematic cross-sectional view of continuous coating apparatus for carrying out a process using the method of the present invention;

FIG. 5 is a graph of the thermal conductivities of nanotube resin composites.

FIG. 6 is a graph of the thermal conductivities of unpurified carbon nanotube resin composites;

FIG. 7 is a graph of the thermal conductivities of unpurified carbon nanotube resin composites cured in a 9 T magnetic field.

### DETAILED DESCRIPTION OF THE DRAWINGS

The following description identifies compositions and methods to prepare carbon nanotube composites in a manner which provides for higher loadings of carbon nanotubes and a greatly simplified and less costly process for producing the composites. Composites comprised of carbon nanotubes with polymers and organic fluids can thereby be produced. Such composites include those involving a matrix consisting of a polymer, adhesive, epoxy, grease, paste, and other organic matrices.

In one current preferred embodiment, a support material loaded with one or metal catalysts is placed in a CVD furnace. Typical conditions used in CVD furnaces for nanotube growth are about 500-1200° C. in the presence of carbon feedstock vapors including, but not limited to, ethylene, methane, propane, carbon monoxide, acetylene, methanol, ethanol, xylene, toluene, and benzene. The preferred flow rates for these gases will depend on the size of the CVD furnace. One preferred embodiment of this invention uses ratios of methane to hydrogen of about 0.2 to 10, and ratios of ethylene to hydrogen of 0 to about 10. The process also consists of a gas purge during cooling after the nanotubes have been formed on the substrates. Gases used for the cooling process are typically nitrogen or argon, or other inert gases. Carbon feedstock such as methanol and ethanol can also be used to grow purer SWNT's. Lower CVD temperatures (about 600-800 C) can be used with these feedstock materials with less amorphous carbon being produced in the process. Aligned nanotubes can also be grown on the metal alloy substrates using carbon feedstock such as ethanol, methanol, benzene, xylene, and toluene. The result of this process is a powdery substance comprising the support material, catalyst, carbon nanotubes, and other carbonaceous entities produced by the CVD process.

We have found that the carbon nanotubes produced by this method can be either single-walled or multi-walled, depending on the CVD process conditions. The carbon nanotubes can have diameters of about 1 to 100 nanometers, and lengths up to 1000's of nanometers. Typical yields of carbon nanotubes plus other carbonaceous entities from the CVD process are about 10 to about 50% relative to the dry catalyst and support weight. The weight percent of pure carbon nanotubes relative to dry catalyst and support weight is typically up to about 40%, although higher yields are possible depending on the CVD process conditions. The one or more metals used on the support preferably comprises up to about 10% by weight relative to the support weight, although higher loadings of up to about 30% by weight have been practiced. Higher loadings of up to about 50% are also contemplated to increase the interconnectivity of the carbon nanotubes and to increase the thermal conductivity of the composite.

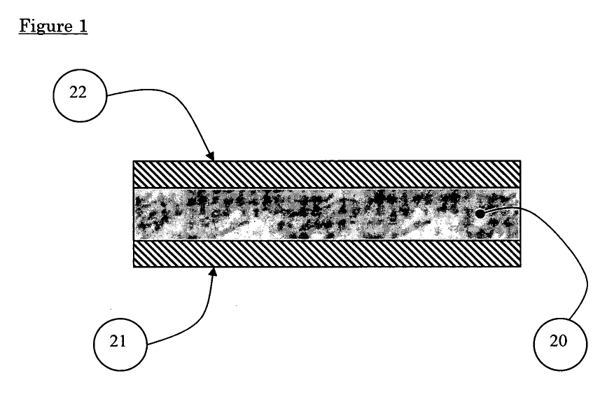

Thermal pastes or greases can be produced by combining the support material, catalysts, carbon nanotubes, and other carbonaceous entities with a fluid to form a thermal paste composite. FIG. 1 depicts a thermal grease or paste 20 applied between two bodies 21 and 22 to conduct heat between the two bodies 21 and 22. Up to about 50% by weight of the support material, catalyst, carbon nanotubes, and other carbonaceous entities can be added to these matrices. We also contemplate higher loadings of up to about 75% by weight. The weight percent of the carbon nanotubes added to the composite matrix can exceed 2% by weight, and up to about 20%. Higher weight percentages of carbon nanotubes up to about 50% are also contemplated. One preferred fluid is a polyolester (or POE) oil. Other organic fluids contemplated by this invention for thermal pastes and greases include, but are not limited to, synthetic oils, natural oils, fluorinated oils, food grade lubricants, silicones, greases, glycols, and ethers. Those skilled in the art will recognize there are numerous other fluids which could serve as a matrix for thermal pastes and greases.

We found surprising results in thermal conductivity when compared to state of the art thermal pastes. The nanotubes do not have to be purified from the support/catalysts material which reduces process steps, and saves production time and cost. A purification step can also damage or destroy carbon nanotubes, altering their thermal conductivity properties. Other oils or organic compounds could be used to form the thermal pastes.

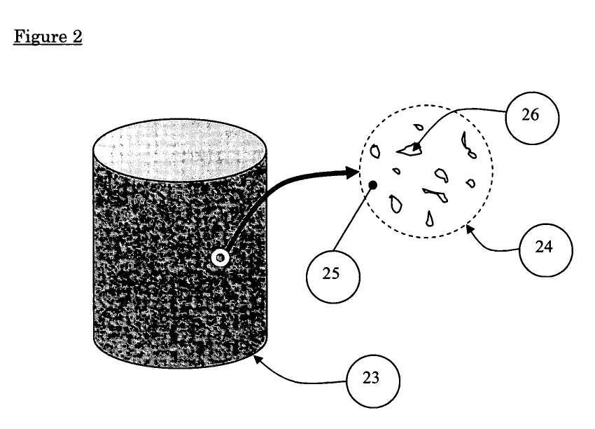

Similarly, carbon nanotubes were grown on support material with metal catalyst and then introduced into polymer resins to form composites. FIG. 2 depicts a composite plug 23 with an exaggerated magnification of a dashed circle area 24 showing the polymer matrix 25, and a particles 26 comprised of carbon nanotubes, support material, catalysts and other carbonaceous species generated by the CVD process. The particles 26 can be comprised of carbon nanotubes in various properties with the support material, metal catalysts, and other carbonaceous entities.

One preferred polymer resin of the present invention is polyester-styrene. The residual support materials and catalyst were not removed by a purification processes prior to combining with the polymer resin. We found surprising increases in thermal conductivity of these composites; the thermal conductivity was better than if purified carbon nanotubes were used alone in the same weight proportions. Hence, we discovered unanticipated benefits to leaving the carbon nanotubes intact with the support material and catalyst without the need to separate the support material and catalyst (i.e., purify). We also discovered that the average particle size of the unpurified nanotube/support/catalyst material was larger than purified nanotubes which allows for higher loadings in composite materials, which in fact allowed for a net higher loading of carbon nanotubes in the thermal pastes.

Carbon nanotubes have a very high surface area and we have found that initiators and resins used to make composites, for example, with pure nanotubes can be adsorbed or otherwise reacted with the carbon nanotubes thereby making if difficult to cure the resins. Prior art demonstrates that loadings in polymer resins substantially comprised of carbon nanotubes exceeding about 2% by weight are difficult to cure, but this method provides the means for carbon nanotube loadings which can exceed about 2%. Polyester resins cured with peroxide initiators are one preferred embodiment of the present invention. Other thermoset and thermoplastic polymers can be used as the matrix for the composites of this invention and we contemplate net increased loadings of carbon nanotubes when they are used in the composite matrix with a support material and catalyst.

Other polymers useful by the methods and compositions of this invention include polyolefins, olefin co-polymers, acrylics, polyvinyls, polyurethanes, ether-derived, polyamides, arylketone-derived, polyphenylene sulfide, polysulfones, polybenzimidazoles, liquid crystal, silicones, polyphosphazenes, polycarborane-siloxanes, siloxanes, polythiazol, parylenes (based on p-xylylene), and formaldehyde resins, as well as biodegradable and natural polymers. The resulting composites could be used as laminates or stand alone structures.

We attribute this unexpected increase in thermal conductivity at least in part to (1) the presence of carbon nanotubes, (2) the remaining support material which may contain a metal such as Al as in alumina (Al₂O₃), (3) residual metal catalysts on the support which have a high thermal conductivity, (4) no purification step which can damage the carbon nanotubes so hence the nanotubes are more pure and unaltered, (5) the connectivity of the carbon nanotubes, support, and metal atoms present in the composites and reduced thermal gap between the individual carbon nanotubes, and (6) synergies between the support material, catalysts atoms, and carbon nanotubes (For example, increased thermal conductivity of the nanotube as a result of metal atoms being present within or on the surface of the nanotubes). The carbon nanotube/support/catalyst can be further ground up by milling or the like to reduce the particle size which we found to further increase the thermal conductivity. Milling to finer powders still allowed for higher loadings than those using pure nanotubes.

With regard to (1) above in the preceding paragraph, carbon nanotubes are known to have very high thermal conductivity and low electrical resistivity. As to (2) in the preceding paragraph, alumina and other support materials can have moderate thermal conductivities thus providing benefits to the overall properties of the composite above the matrix material. Referring to (3) in the preceding paragraph, metal atoms are generally good electrical and thermal conductors and thus their presence enhances electrical and thermal properties. The metal atoms will be present along and within the carbon nanotubes, as well as on the surface of the supports. Regarding (4) in the preceding paragraph, the carbon nanotube will persist in the virgin state at which they were produced. This preserves the longest chains and agglomerates of the carbon nanotubes and their sometimes tangled interconnectivity. Further processing or purification will alter the shape, length, and morphology of the carbon nanotubes and later the connectivity to the support material and metal catalyst atoms resident between the carbon nanotubes and the support, on the carbon nanotubes, and within the carbon nanotube structure. As per (5) of the preceding paragraph, the unexpected thermal properties of these polymers can in part be due to the fact that when using unpurified carbon nanotubes at higher weight percent loading, the nanotube-to-nanotube junction gap is minimized reducing thermal resistance. The presence of conductive metals used as the growth media also reduces this junction resistance by providing a conductive environment between the nanotubes. Since the carbon nanotubes are grown from the metal catalysts atoms, the nanotubes will also be directly attached to their surface thereby creating a continuous conducting network through the particulates comprising the composites.

Carbon nanotube composites also are reported to exhibit superior strength. Some difficulties have arisen with regard to the achieving strong interfaces between the polymer matrix and carbon nanotubes. This problem has been partially addressed by functionalizing the carbon nanotubes. The present invention provides for strong interfaces between the polymer and carbon nanotube by providing an additional surface, namely the support material, to which the polymer can develop very strong interfaces at or near the carbon nanotube-support material interface and carbon nanotube-metal interface. This provides additional benefits in producing strong polymeric composites.

We also contemplate the advantages surprising benefits of this invention for epoxies and adhesives. Typical epoxies known by those skilled in the art include, but are not limited to, polyesters, methacrylates, cyanoacrylates, acrylates, and bisphenol/epichlorohydrin with n-butyl glycidyl ether. Fillers used in these epoxies are similar to those used in pastes. Adhesives are typically categorized as drying adhesives, hot adhesives, temporary adhesives, and reactive adhesives. The most common reactive adhesives are epoxies.

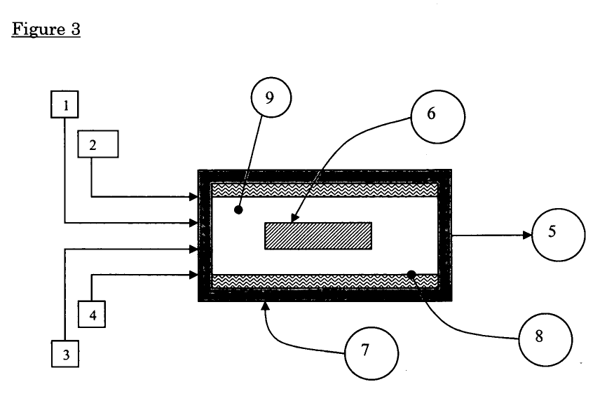

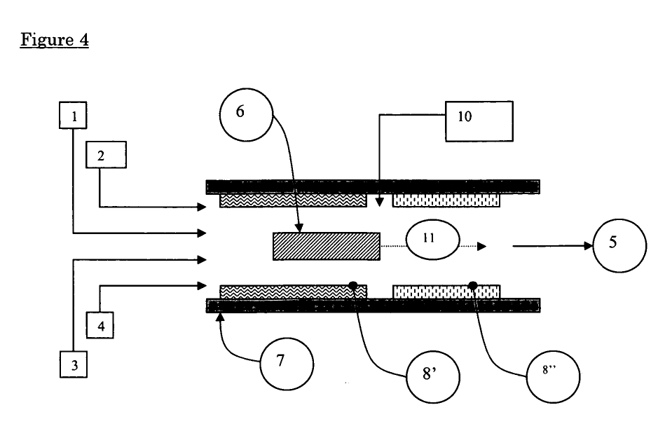

The carbon nanotube material of the present invention can be produced in a batch or continuous feed process as illustrated by FIGS. 3 and 4. In those figures, carbon feedstock and purge gases designated by numerals 1 through 4 can be introduced into a furnace 9 heated by a heater 8 and provided with insulation 7, and exhausted through an exhaust port 5. The substrate 6 is subjected to the gases 1 through 4 at a temperature of about 500-1200° C. The gases 1 through 4 can be controlled by pressure and/or flow control devices, and the pressure in the furnace 9 can be sub-atmospheric, atmospheric or high pressure. In a continuous mode, the substrate can be conveyed through a furnace by a conveying device 11 with one or more heating zones defined spatially by heaters 8′ and 8″. Additional gases can be introduced (illustrated schematically by numeral 10 in FIG. 4) along its length so as to vary the environment in the chamber. For example, the substrate comprising a catalysts support and catalyst can be subjected to carbon feedstock gases in one zone at temperature T8′ (corresponding to heating zone and heater 8′), and then cooled with a purge gas at T8″ (corresponding to heating zone and heater 8″) in a second zone. The nanotube CVD growth process can last from about 10 minutes up to several hours.

The preferred metal catalysts of this invention should promote the growth (i.e., catalyze) of carbon nanotubes. It is also preferred that these metal catalysts have a high thermal conductivity so as to enhance the thermal conductivity of the resulting composites when the support material, catalyst, carbon nanotubes, and other carbonaceous entities are combined with a composite matrix. The metals which can be used as catalysts and which can provide some of the added benefits in thermal conductivity include most transition metals, but those with high thermal conductivities such as silver (Ag), copper (Cu), aluminum (Al), gold (Au), zinc (Zn), rhodium (Rh), iridium (Ir), beryllium (Be), nickel (Ni), chromium (Cr), tungsten (W), cobalt (Co), molybdenum (Mo), calcium (Ca), ruthenium (Ru), cadmium (Cd), chromium (Cr), lithium (Li), iron (Fe), and silicon (Si) are preferred since many of these also are nanotube growth catalysts. All these metals have thermal conductivities greater than about 80 W/m-K. Other metals which can promote nanotube growth as catalysts include yttrium (Y), titanium (Ti), iridium (Ir), osmium (Os), palladium (Pd), platinum (Pt), rhodium (Rh), lead (Pb), zirconium (Zr), manganese (Mn), and vanadium (V) and oxide thereof.

For pastes, greases, epoxies, adhesives, and polymer resin composites, similar benefits are anticipated when using other catalyst supports such as alumina, silica, carbon, zeolites, or combinations thereof. Higher thermal conductivity materials are preferred, and those skilled in the art will recognize that within these classifications of supports that some variety is available. As an example, the average thermal conductivity of alumina is about 30 W/m-K, but different morphologies of this support may produce values less than or greater than this.

The thermal and electrical properties of these composites could be further modified by adding other fillers such as oxides, metal particles and amorphous carbon.

### EXAMPLE 1

Experiments have shown that the addition of even slight amounts of carbon nanotubes have profound effects on the thermal conductivity of the composite. Polyester-polystyrene resin composites were formed using a peroxide initiator and varying amounts of alumina support, Fe and Mo catalyst, carbon nanotubes, and other carbonaceous entities produced in a CVD process.

The thermal conductivity K of a material is defined by the equation Q=AK(dT/dx), where Q is the heat flow (e.g. BTU/hr or watts, W), A is the area perpendicular the direction of heat flow (e.g., square feet or square meters), dT is the differential temperature (e.g. degrees F or degrees K), and dx is the thickness through which the heat flows (e.g., feet or meters). The thermal conductivity K is a proportionality constant that relates the heat flux Q/A to the temperature gradient dT/dx, and has dimensions of, for example, BTU/ft-hr-F or W/m-K. In the following figures, the value for K is reported at the average temperature of the composite (T_{cold}+Tₕₒₜ)/2, where T_{cold} is the temperature of the cold face of the composite, and Tₕₒₜ is the temperature of hot face of the composite. The gradient dT/dx was computed as (T_{cold}+Tₕₒₜ)/xₜ, where xₜ is the thickness of composite sample (typically 0.4-0.6 inches).

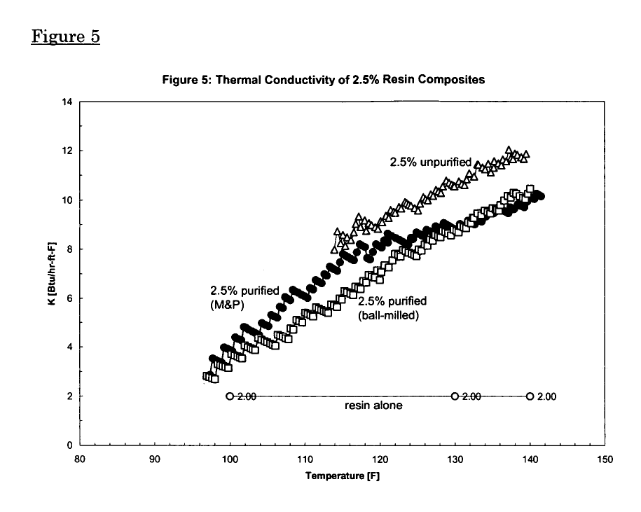

FIG. 5 shows the thermal conductivity K of four materials: (1) polymer resin without any carbon nanotubes, (2) resin composite with 2.5% unpurified carbon nanotubes, and (3) a resin composite with 2.5% purified carbon nanotubes which were ground by Mortar and Pestle (“M&P”), and (4) a resin composite comprised of 2.5% purified carbon nanotubes which were ground by ball milling. Referring to FIG. 5, the thermal conductivity of purified and unpurified nanotubes 2.5% loading in a resin is essentially identical. The thermal conductivity is also greater than the resin alone by about 3-5 times greater at 120° F., and 5-6 times greater at 140° F.

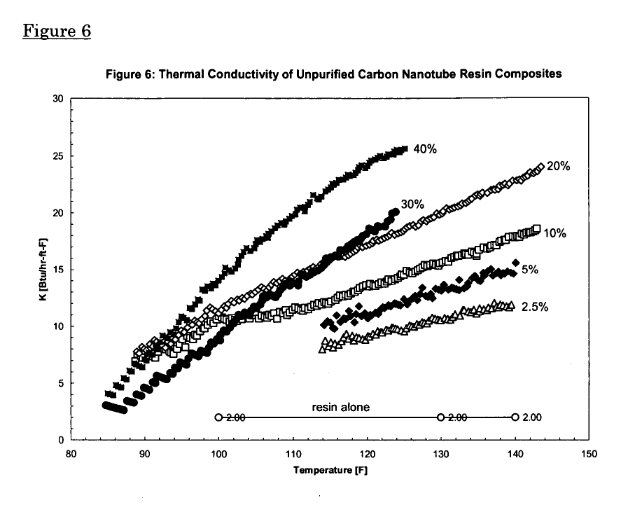

FIG. 6 shows the thermal conductivity K for a series of composites fabricated with unpurified carbon nanotubes. The value for K increases as the loading increases from 2.5% to 40%, and all values are greater than resin alone. For unpurified carbon nanotube support, catalyst and other carbonaceous entities at 40% by weight in the resin, we measured a thermal conductivity of 41 W/m-K (24 BTU/hr-ft-F) compared to the thermal conductivity of the base resin of about 3.5 W/m-K (2 BTU/hr-ft-F). The quantity of carbon nanotubes in this composite was about 5% by weight. This represents an improvement in the thermal conductivity of 1100%.

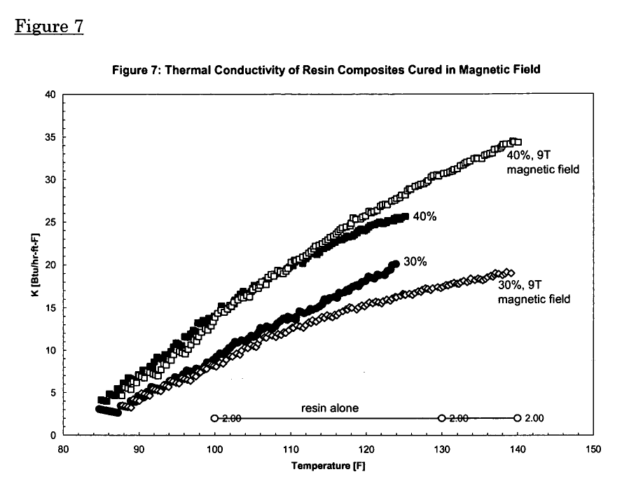

FIG. 7 shows how the thermal conductivity K varies when unpurified carbon nanotubes are subjected to a nine Tesla (T) magnetic field while curing. Note that the aligning of the nanotubes in the magnetic field did not improve the thermal conductivity of the composite, but all K values were greater than the resin alone.

We had expected that purified nanotube composites would have had a much greater benefit since the total concentration of carbon nanotubes is greater. However, we were surprised to find that this was not supported by the data. As shown in FIG. 5, the 2.5% unpurified and the 2.5% purified carbon nanotubes (both ball-milled and mortar and pestle ground) have essentially the same thermal conductivity. Hence, there are no advantages over using purified carbon nanotubes which increases processing costs. Furthermore, attempts to cure resins with high amounts of purified carbon nanotubes was not possible, whereas higher net loadings of carbon nanotubes were possible if left in an unpurified form containing the support material, catalysts, and other carbonaceous species produced by the CVD process.

### EXAMPLE 2

Polymer composites similar to those described in example 1 were produced with net carbon nanotubes loadings of 2% to 25%.

### EXAMPLE 3

Experiments were performed to determine if unpurified carbon nanotubes could be mixed with a POE oil to form a non-curing thermal joint compound, also commonly referred to as thermal grease or paste. We found that the unpurified nanotubes had to be milled to produce a finer powder to be used as an effective thermal paste. Experiments have shown that for the temperature range tested, namely temperature gradients between about 15 to 50° C., the thermal resistance of the dry copper joint was constant at 0.0013° C.-m²/Watt, The thermal resistance of the essentially identical copper joint (tested simultaneously in parallel) which was coated with an unpurified nanotube thermal paste displayed a thermal resistance of only 0.0004° C.-m²/Watt. That represents a 69% reduction in the thermal resistance relative to the dry joint. The unpurified nanotubes could be added to this oil matrix in about 2% to 80% by weight.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A method for producing a carbon nanotube composite, comprising growing carbon nanotubes on a support substrate and metal catalyst, and combining said carbon nanotubes, support substrate, and catalyst in at least a partially unpurified form with a matrix material.

2. Method according to claim 1, wherein the support substrate is at least one selected from the group consisting of alumina, silica, carbon, and zeolites.

3. Method according to claim 1, wherein the catalyst is at least one selected from the group consisting of transition metals and oxides thereof.

4. Method according to claim 1, wherein the metal catalyst is comprised of at least one metal selected the group consisting of silver (Ag), copper (Cu), aluminum (Al), gold (Au), zinc (Zn), rhodium (Rh), iridium (Ir), beryllium (Be), nickel (Ni), chromium (Cr), tungsten (W), cobalt (Co), molybdenum (Mo), calcium (Ca), ruthenium (Ru), cadmium (Cd), chromium (Cr), lithium (Li), iron (Fe), yttrium (Y), titanium (Ti), iridium (Ir), osmium (Os), palladium (Pd), platinum (Pt), rhodium (Rh), lead (Pb), zirconium (Zr), manganese (Mn), vanadium (V) and silicon (Si) and oxides thereof.

5. Method of claim 1, wherein the matrix material is at least one selected from the group consisting of polymers, epoxies, adhesives, oils, organic liquid, pastes, and greases.

6. Method according to claim 5, wherein the polymer is one of a thermoset or thermoplastic.

7. Method of claim 5, wherein the polymer is at least one selected from the group consisting of polyolefins, olefin co-polymers, acrylics, polyvinyls, polyurethanes, ether-derived, polyamides, arylketone-derived, polyphenylene sulfide, polysulfones, polybenzimidazoles, liquid crystal, silicones, polyphosphazenes, polycarborane-siloxanes, siloxanes, polythiazol, parylenes, formaldehyde resins, biodegradable, natural polymers, adhesives, and epoxies.

8. Method according to claim 1, wherein the matrix material is at least one of polyolester (POE) oil, mineral oil, synthetic oil, silicone, glycol, ether, fluorinated oil, grease, and food grade lubricant.

9. Method of using a composite produced by the method of claim 1, wherein the use is in a device for heat transfer.

10. Carbon nanotube composites made by the process comprising
(a) growing carbon nanotubes on a support substrate and metal catalyst;
(b) optionally milling the carbon nanotubes, support substrate and metal catalyst in at least a partially unpurified form;
(c) combining the at least partially unpurified carbon nanotubes, support substrate and metal catalyst with a polymer.

11. The composite of claim 10, wherein the polymer is at least one selected from the group consisting of polyolefins, olefin co-polymers, acrylics, polyvinyls, polyurethanes, ether-derived, polyamides, arylketone-derived, polyphenylene sulfide, polysulfones, polybenzimidazoles, liquid crystal, silicones, polyphosphazenes, polycarborane-siloxanes, siloxanes, polythiazol, parylenes formaldehyde resins, biodegradable, natural polymers, adhesives, and epoxies.

12. Carbon nanotube paste and grease composite made by the process comprising
(a) growing carbon nanotubes on a support substrate and metal catalyst;
(b) optionally milling the carbon nanotubes, support substrate, and metal catalyst; and
(c) combining the at least partially unpurified carbon nanotubes, support substrate and metal catalyst with a matrix material.

13. The composite of claim 12, wherein the matrix material is at least one of polyolester (POE) oil, mineral oil, synthetic oil, silicone, glycol, ether, fluorinated oil, grease, and food grade lubricant.

14. Carbon nanotube epoxy and adhesive composite made by the process comprising
(a) growing carbon nanotubes on a support substrate and metal catalyst;
(b) optionally milling the carbon nanotubes, support substrate, and metal catalyst; and
(c) combining the at least partially unpurified carbon nanotubes, support substrate and metal catalyst with a matrix material.

15. The composite of claim 14, wherein the matrix material is at least one of methacrylates, polyesters, cyanoacrylates, acrylates, and bisphenol/epichlorohydrin with n-butyl glycidyl ether.

16. Method of using a composite of claim 14, wherein the composite is used for at least one of drying adhesive, hot adhesive, temporary adhesive, and reactive adhesive.

17. Method according to claim 1, wherein the carbon nanotubes are at least one selected from the group consisting of single-walled and multi-walled.

18. Method according to claim 1, wherein the carbon nanotubes consist of at least one selected from the group consisting of armchair, zig-zag, and chiral allotropes.
